(19) United States
(12) Patent Application Publication
(10) Pub. No.: US 2013/0052605 A1
(43) Pub. Date: Feb. 28, 2013

(54) BUCCAL FIXTURE FOR ORTHODONTIC USE

(71) Applicant: Jang Hoon Ahn, Seoul (KR)

(72) Inventor: Jang Hoon Ahn, Seoul (KR)

(21) Appl. No.: 13/696,309

(22) PCT Filed: Apr. 19, 2011
(86) PCT No.: PCT/KR2011/002769

§ 371 Date: Nov. 6, 2012

(30) Foreign Application Priority Data
May 6, 2010 (KR) 10-2010-0042636

(51) Int. Cl. A61C 7/00

(52) U.S. Cl. 433/18

(57) ABSTRACT

The present invention relates to a buccal fixture for orthodontic use, including a base part having at least two screw holes and a hook piece which extends from the base part toward the side. The hook piece includes: a first hook part at which a first opening is opened to one side direction and a second hook part at which a second opening is opened to a direction opposite to the opened direction of the first opening are formed on the hook piece. According to the present invention, the buccal fixture to be implanted to a gum at a molar tooth side can be used for both left and right side or upper jaw and lower jaw. Accordingly, an error can be prevented originally that the buccal fixture is implanted to a wrong position due to confusion between the left and right fixtures by an operator.

### TECHNICAL FIELD

The present invention relates to an orthodontic appliance for correcting a set of teeth, and more particularly, to a buccal fixture for orthodontic use.

### BACKGROUND ART

In general, a plate or a steel wire is arranged on teeth and it is supported through an orthodontic fixture to correct a set of teeth. At this time, constant tension is applied to an intended direction for correction so that the teeth are gradually moved to a normal position. That is, the steel wire for orthodontics is fixed to a plate that is attached to front or rear faces of teeth for continuous correction of a dentition (a set of teeth). For this correction of the set of teeth, a certain fixture is necessary for applying tension to the set of teeth to be corrected.

A fixture attachment procedure, an important orthodontic treatment procedure for properly and functionally arranging a set of teeth, can be performed while a height and angle of a fixture is adjusted properly by an operator. In a normal occlusal (matching-bite) set of teeth, the respective teeth have to be placed essentially at a specially required position while keeping their proper shapes. The height is lowered gradually from incisor tooth (front tooth) toward molar tooth. An incisor tooth, canine tooth and molar tooth have to be arranged to maintain a proper sloping angle to chew, speak, swallow functionally and to present an elegant appearance.

Meanwhile, a prior buccal fixture for orthodontic use that is implanted to an inner side or outer side of the gum at left and right molar teeth. The buccal fixture is used for a rear movement of incisor tooth part (front tooth), a rear movement of molar tooth, and a downward movement of incisor tooth part. The buccal fixture that is implanted in the gum at a left molar tooth side and the buccal fixture that is implanted in the gum at a right molar tooth side are mirror symmetrical. For example, a hook over which a traction member (for example, rubber wire or spring for medical treatment) connected to a steel wire is caught has to be installed on the buccal fixture in order to move the steel wire that is fixed to a plate attached on a incisor tooth rearward. In addition, the hooks of the left and right fixtures are shaped to be directed in opposite directions. Accordingly, if the left and right fixtures are implanted in wrong positions due to confusion, they have to be removed from the wrong position, causing inconvenience and pain to a person receiving the buccal fixture. Nevertheless, the fixtures to be implanted to the left and right sides of gum are shaped similarly and may cause confusion to an operator using the prior buccal fixture.

### DISCLOSURE

### Technical Problem

The present invention has been proposed to solve the problem of a prior buccal fixture and an object of the present invention is to provide a buccal fixture for orthodontics, capable of being co-implanted to the left and right gums (or upper and lower jaws) of a recipient.

Another object of the present invention is to provide a buccal fixture for orthodontics, capable of minimizing an implant area of the gum at a molar tooth side of a recipient.

### Technical Solution

According to an aspect of the present invention, a buccal fixture for orthodontics according to the present invention includes: a base part in which at least two screw holes are formed; and a hook piece extended to one side from the base part. Here, the hook part includes a first hook part at which a first opening is opened to one side direction and a second hook part at which a second opening is opened to an opposite direction to the opened direction of the first opening.

Specially, the hook piece may be stepped from the base part, and furthermore a first and second pairs of catching parts bent toward a hook center of the first and second hook parts may be formed on both sides of the first and second openings. Further, the hook piece may be extended from a center or one end of the base part.

### Advantageous Effects

In the buccal fixture for orthodontics according to the present invention, the buccal fixture to be implanted to a gum at a molar tooth side can be used for both left and right side (or upper jaw and lower jaw). Accordingly, an error can be prevented originally that the buccal fixture is implanted to a wrong position due to confusion between the left and right fixtures by an operator.

Further, in view of manufacturing point, for example, when a buccal fixture is fabricated by using a mold, the molds of the left and right fixtures are not necessary to be fabricated separately to save manufacturing process and cost.

Furthermore, the buccal fixture according to the present invention can minimize the area to be implanted to a gum of a recipient, and thus the area of incising and peeling off skin tissue can be minimized, and further the hook part formed on the hook piece is configured for a spring or rubber wire that is caught thereover not to be detached easily therefrom thereby applying stable tension for orthodontics.

### BRIEF DESCRIPTION OF THE DRAWINGS

FIG. 1 is a flat view of a buccal fixture according to an example of an embodiment of the present invention.

FIG. 2 is a right side view of a buccal fixture shown in FIG. 1, according to an example of an embodiment of the present invention.

FIG. 3 is a flat view of a buccal fixture according to another example of an embodiment of the present invention.

FIG. 4 is a side view of a buccal fixture shown in FIG. 3, according to an example of an embodiment of the present invention.

FIG. 5 is a view of a buccal fixture shown in FIG. 1, which is implanted to a gum at a right molar tooth side of a recipient.

FIG. 6 is a view of a buccal fixture shown in FIG. 1, which is implanted to a gum at a left molar tooth side of a recipient.

### BEST MODE

Examples of embodiments of the present invention will be described below in detail with reference to the accompanying drawings. Wherever possible, the same reference numerals will be used to refer to the same elements throughout the specification, and a duplicated description thereof will be omitted. It will be understood that although the terms “first”, “second”, etc. are used herein to describe various elements, these elements should not be limited by these terms. These terms are only used to distinguish one element from another element.

A buccal fixture for orthodontics according to the present invention includes: a base part in which at least two screw holes are formed; and a hook piece extended to one side from the base part. Here, the hook part includes a first hook part at which a first opening is disposed facing one side direction and a second hook part at which a second opening is disposed facing a side direction opposite to the direction of the first opening.

Specially, the hook piece may be stepped from the base part, and furthermore a first and second pairs of catching parts bent toward a hook center of the first and second hook parts may be formed on both sides of the first and second openings. Further, the hook piece may be extended from a center or one end of the base part.

### MODE FOR THE INVENTION

Hereinafter, preferable embodiments of a buccal fixture for orthodontics according to the present invention will be described in detail, referring the accompanying drawings.

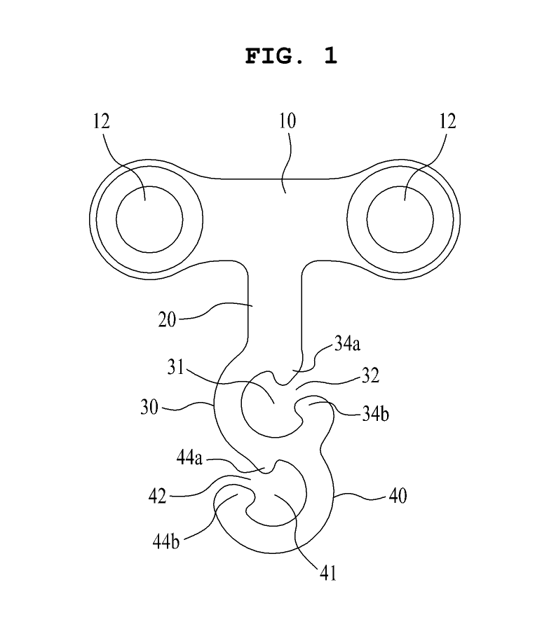

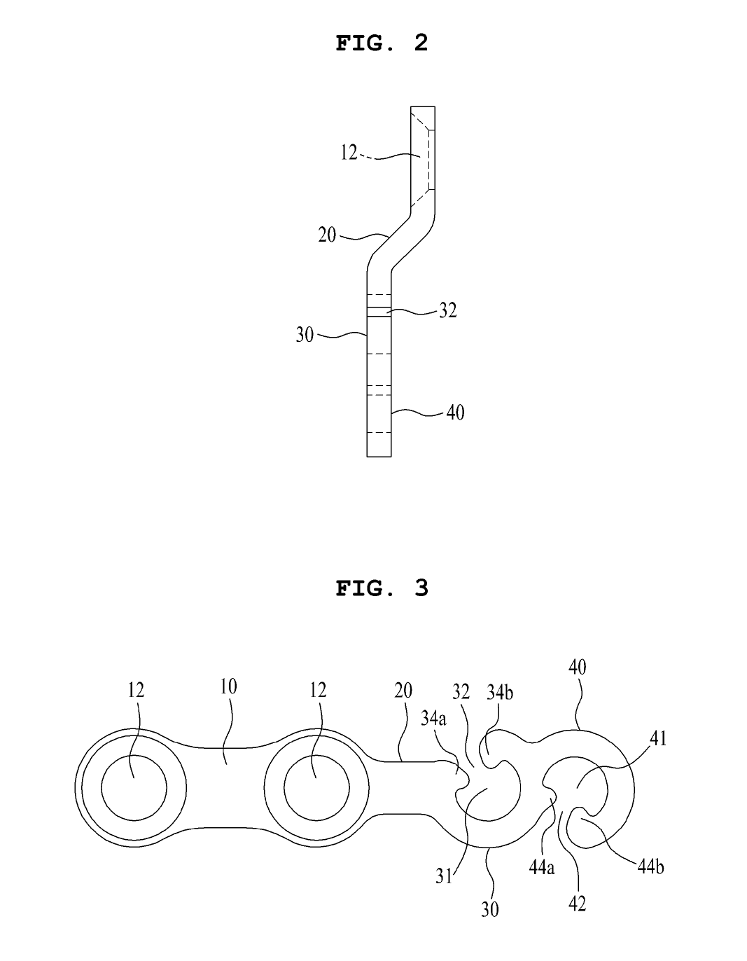

First, referring to FIGS. 1 and 2, to 4, a buccal fixture for orthodontics of “T” shape according to an example of an embodiment will be described as followings. As shown in FIG. 1, the buccal fixture according to the present embodiment may include a base part 10 and a hook piece 20. Here, two screw holes 12 are formed on the base part 10 wherein predetermined screws are implanted to inner and/or outer gums of a recipient through the screw holes in order to use the buccal fixture as a stable anchor for orthodontics. Here, at least two screws holes 12 are necessary to function as the stable anchor for orthodontics; however, the number of the screw hole is not limited thereto, and it can be increased, if necessary.

Further, the hook piece 20 is extended to one side from the base part 10. Here, the term “extended” can mean not only that the hook piece 20 can be formed integrally with the base part but also that the hook piece can be fabricated separately and then is connected to the base part. Specially, in the buccal fixture of “T” shape according to the present embodiment, the hook piece 20 is extended from a center of the base part 10 (that is, an area between two screw holes). Further, two hook parts 30, 40 are formed on one end of the hook piece 20. Here, a first hook part 30 and a second hook part 40 are formed consecutively wherein a first opening 32 opened to one side is formed on the first hook part 30 and a second opening 42 opened to opposite direction to the open direction of the first opening 32 is formed on the second hook part 40. The first and second hook parts 30, 40 have a hook shape with the first and second openings 32, 42 wherein a traction member such as spring or rubber wire for medical treatment can be caught over the hook.

Specially, the opened direction of the first opening 32 is almost opposite to the opened direction of the second opening 42, and thus the buccal fixture according to the present embodiment can be used, regardless of left or right, and upper jaw or lower jaw molar tooth of a recipient. That is, the first hook part 30 or the second hook part 40 may be selected properly to correspond to a catching angle of the traction member and thus the same shape of the buccal fixture may be used, regardless of the operational positions. Here, the opened direction of the first opening 32 is angled right-upward at 45 degree on a drawing in FIG. 1, the opened direction of the second opening 42 is angled left-upward at 45 degree. Although, the opened directions of the first and second openings 32, 42 are not necessarily completely opposite the opened directions may be approximately opposite.

Meanwhile, a first pair of catching parts 34a, 34b may be formed on both sides of the first opening 32 of the first hook part 30. The catching parts 34a, 34b are bent toward a hook center 31 of the first hook part 30, and for example, they have an area projected toward the inside of the hook, respectively. Furthermore, a second pair of catching parts 44a, 44b may be formed on both sides of the second opening 42 of the second hook part 40. The catching parts 44a, 44b are also bent toward a hook center 41 of the second hook part 40. The first and second pairs of catching parts 34a, 34b; and 44a, 44b as described above allow the traction members to be caught over the respective hook parts 30, 40 not to be detached easily and the buccal fixture to provide stable fixing force.

Furthermore, as shown in FIG. 2, the hook piece 20 may be offset from the base part 10 to minimize the area to be implanted to gum of a recipient. Further, the buccal fixture may be made of soft material so that an operator can adjust a sloping angle of the hook piece as desired. The buccal fixture according to the present invention may be made of titanium alloy wherein the titanium alloy comprises, for example, 0.20 wt % O, 0.05 wt % N, 0.08 wt % C, 0.015 wt % H, 0.40 wt % F, 5.5-6.75 wt % Al, 3.5-4.5 wt % V, 0.4 wt % other inclusions. Further, the soft material used for the buccal fixture according to the present invention may have at least 825 MPa yield strength, at least 895 MPa ultimate strength, at least 10% elongation at 50 mm, and at least 20% reduction per unit area.

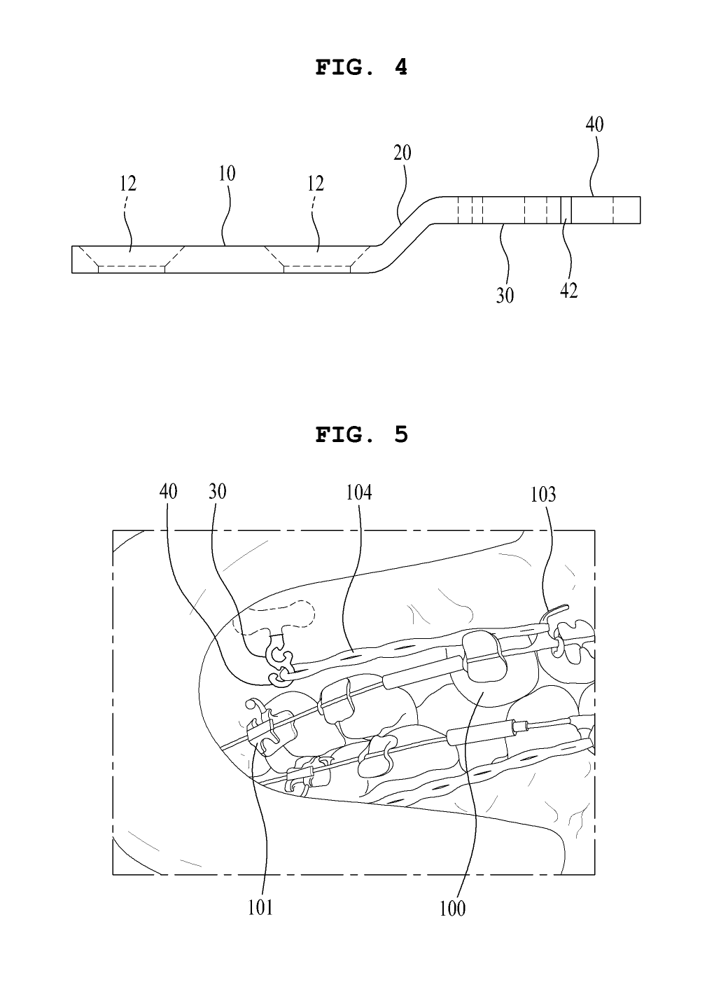

FIGS. 3 and 4 show a buccal fixture having an “I” shape according to another embodiment of the present invention. For reference, like reference numerals in the buccal fixtures of “T” shape and “I” shape refer to like elements throughout, and the shape and function of the elements in the buccal fixture of “I” shape, referring as same reference numerals, are the same as those of the buccal fixture of “T” shape. However, there is a difference in the buccal fixture of “I” shape from the buccal fixture of “I” shape in that the hook piece 20 is extended from one end of the base part 10 (that is, one side end in which one screw hole is formed).

Furthermore, the buccal fixture with a “T” shape and the buccal fixture with an “I” shape are only described as examples of embodiments, and further the locations where the base part 10 and the hook piece 20 are coupled may be varied. For example, as a variation of the buccal fixture of “I” shape, the base part 10 and the hook piece 20 may be sloped each other at a predetermined angle (that is, as shown in FIG. 3, the hook piece 20 is bent at a predetermined angle from the base part 10). The angle may be varied properly depending on the set state of tooth, a gum bone structure of a recipient.

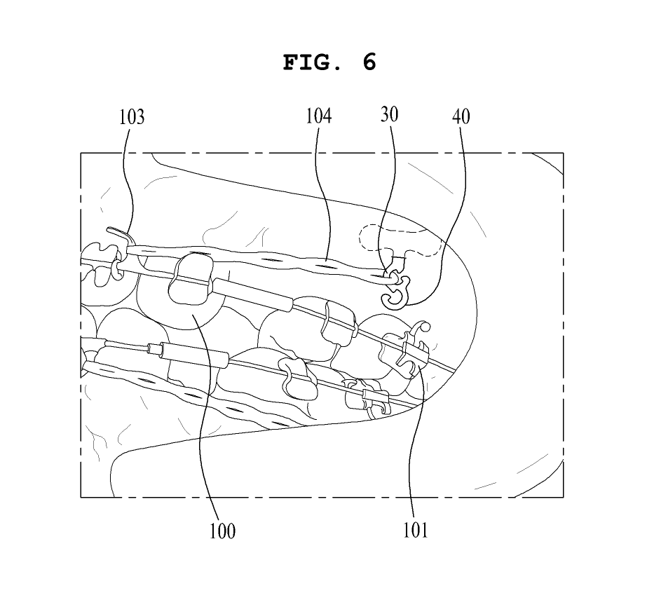

Meanwhile, the buccal fixture according to the present invention can be used, regardless of left and right sides (or upper and lower jaws) of a recipient, and for example, referring to FIGS. 5 and 6, it will be described that the buccal fixture of “T” shape can be used, regardless of left and right sides of a recipient. That is, in case of moving rearward an incisor tooth of a recipient, one end of a rubber wire 104 for medical treatment is caught over one end of a steel wire 103 fixed to a plate 101 attached on a tooth 100, and the other end of the rubber wire is fixed to the hook part 30 or 40 of the buccal fixture. At this time, the buccal fixture may be implanted to the respective right-upper and left-upper jaws of a recipient wherein as shown in FIG. 5, the buccal fixture is implanted to the right-upper jaw of a recipient and then the rubber wire 104 is caught over the second hook part 40 to move rearward the incisor tooth, and at the same time, as shown in FIG. 6, the same buccal fixture is implanted to the left-upper jaw of a recipient and then the rubber wire 104 is caught over the first hook part 30 to move rearward the incisor tooth. Specially, it is noted that the buccal fixtures used in FIGS. 5 and 6 are the same shapes, and even when the same shape of the buccal fixture according to the present invention is used, regardless of left-right sides of a recipient, it can be used as a stable anchor for orthodontics.

The present invention relates to an orthodontic appliance used for correcting a set of teeth.

In the buccal fixture for orthodontics according to the present invention, the buccal fixture to be implanted to a gum at a molar tooth side can be used for both left and right side (or, upper jaw and lower jaw). Accordingly, an error can be prevented originally that the buccal fixture is implanted to a wrong position due to confusion between the left and right fixtures by an operator.

Further, in view of manufacturing point, for example, when a buccal fixture is fabricated by using a mold, the molds of the left and right fixtures are not necessary to be fabricated separately to save manufacturing process and cost.

Furthermore, the buccal fixture according to the present invention can minimize the area to be implanted to a gum of a recipient, and thus the area of incising and peeling off skin tissue can be minimized, and further the hook part formed on the hook piece is configured for a spring or rubber wire that is caught thereover not to be detached easily therefrom thereby applying stable tension for orthodontics.

While the present invention has been described with respect to the specific embodiments, it will be apparent to those skilled in the art that various changes and modifications may be made without departing from the spirit and scope of the invention as defined in the following

1. A buccal fixture for orthodontics comprising:
a base part in which at least two screw holes are formed; and
a hook piece extended to one side from the base part wherein a first hook part at which a first opening is opened to one side direction and a second hook part at which a second opening is opened to a direction opposite to the opened direction of the first opening are formed on the hook piece.

2. The buccal fixture for orthodontics of claim 1, wherein the hook piece forms a step with the base part.

3. The buccal fixture of claim 1, wherein a first pair of catching parts bent toward a hook center of the first hook part are formed on both sides of the first opening.

4. The buccal fixture of claim 1, wherein a second pair of catching parts bent toward a hook center of the second hook part are formed on both sides of the second opening.

5. The buccal fixture of claim 1, wherein the hook piece is extended from a center of the base part.

6. The buccal fixture of claim 1, wherein the hook piece is extended from one end of the base part.
